(19) United States
(12) Patent Application Publication
(10) Pub. No.: US 2012/0236003 A1
(43) Pub. Date: Sep. 20, 2012

(54) Real-Time Visualization of Data Through a Bottleneck

(75) Inventors: Mathew Lee, Oklahoma City, OK (US); Paul Beard, Bigfork, MT (US)

(73) Assignee: Dechnia, LLC, Colorado Springs, CO (US)

(21) Appl. No.: 13/209,930

(22) Filed: Sep. 26, 2011

Related U.S. Application Data
(60) Provisional application No. 61/435,694, filed on Jan. 24, 2011.

(51) Int. Cl. G06T 11/20

(52) U.S. Cl. 345/440.1

(57) ABSTRACT

Transferring a dataset larger than the packet size requires may require that the data be split over multiple transfers. This technique describes the ability to represent that starting packet in such a way that it gives the gross details of your original data set. Subsequent transfers will fill in the additional data so that the full detailed data is eventually displayed. This allows you to provide the user with the ability to see the partial dataset without waiting for the entire data to be transferred. This may be important in mobile applications where the power consumption is limits the performance of the system.

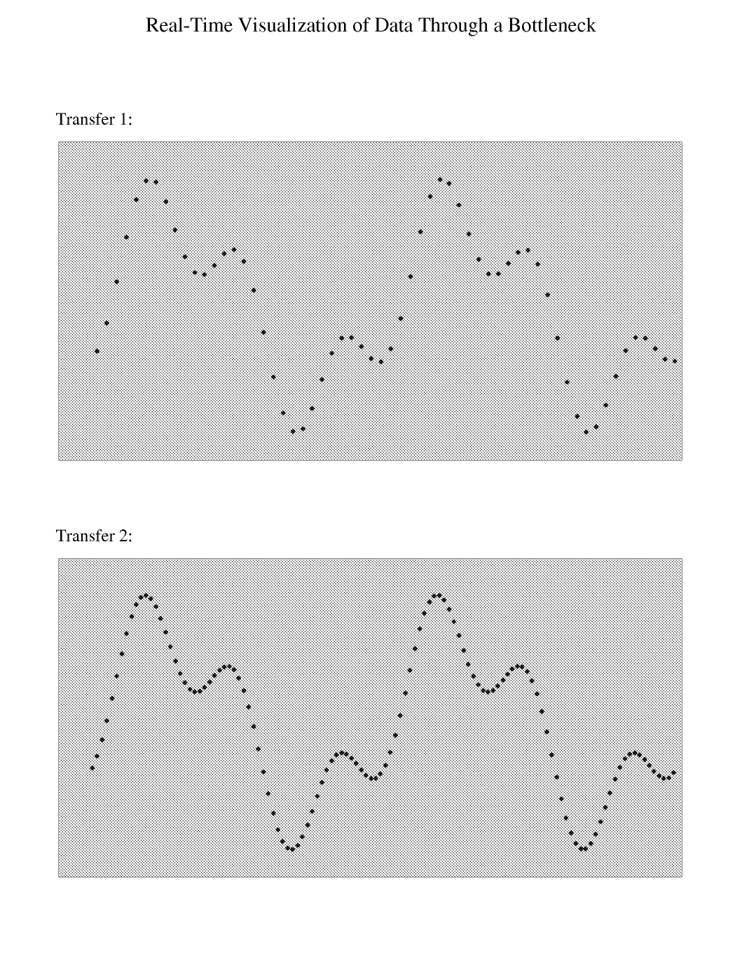

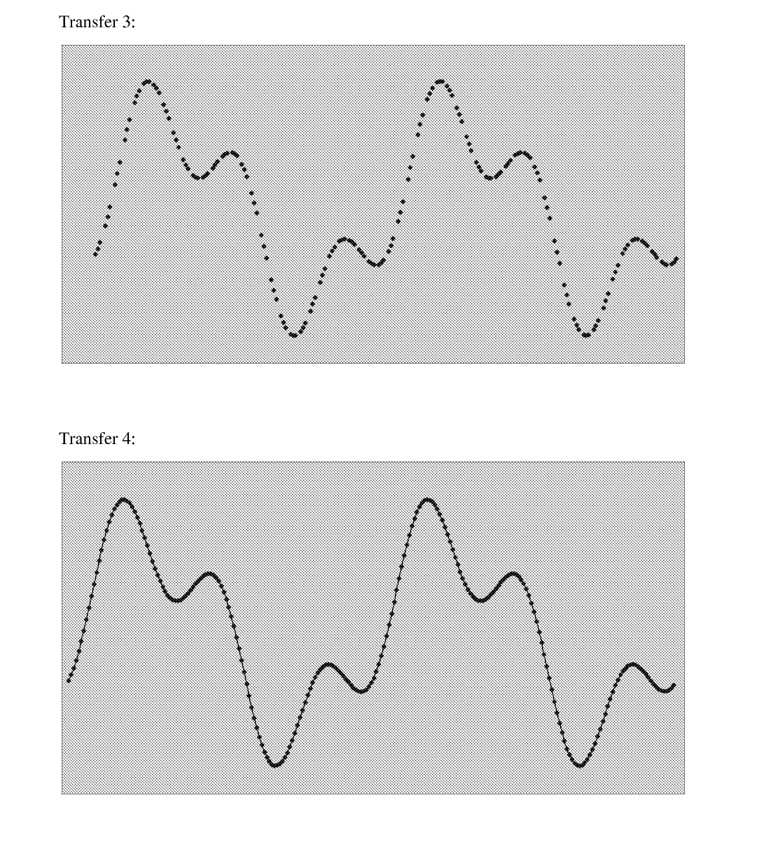

Claiming priority for earlier filed provisional patent Application No. 61/435,694 on Jan. 24, 2011

### DESCRIPTION

The invention provides a method for one to transfer data for visualization when the available data bandwidth is lower than the required data rate. This is accomplished by selectively sending the data through the bottleneck over multiple intervals in such a way that the gross features are shown over the first transfer and the details are filled in over the subsequent transfers. The data can be selected as important or interleaved with a fixed spacing so that the visualization grows in sharpness over time.

### INFORMATION

Typical data visualization requires large amounts of bandwidth as the pixel count increases. Many handheld devices (such a mobile phones) have a communication interface but in many cases, it is not possible to transfer all of the data for display in a given amount of time. The invention allows one to get the real-time data in front of the user without showing all the details at the first time interval. Over time, the details will be filled out so that the full set of data is in front of the user.

### IMPLEMENTATION

In this example, a complex sin wave that has 240 points needs to be transferred. The goal would be to transfer for this all at once so that the user could experience the entire set of data at one time. But because of a communication bottleneck, the data is split into 4 sets. This allows the graphics display to begin to represent the wave without all the details on the first transfer.

With the proposed invention, the data is interleaved and split into multiple transfers. This split can be done where important information is selected, or it can be location based.

After all transfers have been completed, post processing can be completed (such as sinc or spline interpolation). The key to the invention is that after the first transfer, the overall waveform is evident even though the details have not yet been filled in.

The following explanation illustrates the claims. Each transfer is reference by a drawing:

Transfer #1

Although the details are not present, the overall shape of the waveform is apparent

Transfer #2

The waveform is more evident than in the first transfer.

Transfer #3 This transfer shows that the data does not need to be evenly spaced at all times and cannot unless the data is transferred in two sets. Because this state is shown for only a short time, the eye tends to ignore the missing 4th pixel. In fact, the eye tends to fill in the data.

Transfer #4

All transfers are now completed and the waveform has been reconstructed.

What is claimed is:

1. This invention allows provides a method to display a complex waveform by transferring portions of it over multiple intervals.

2. This invention allows data to be processed over multiple intervals in such a way that it can be location based.

3. This invention allows data to be processed over multiple intervals in such a way that it is selected based on an important feature such as a discontinuity, large change in value or other identified feature.

4. This invention allows for data to be processed with sinc, spline, or other interpolation technique over the multiple intervals or after the data is completely received.

5. This invention allows the waveform to become evident where the general shape is known before all of the details have been provided.
